(19) United States
(12) Patent Application Publication
(10) Pub. No.: US 2008/0179847 A1
(43) Pub. Date: Jul. 31, 2008

(54) All-terrain cooler

(76) Inventor: Thomas Andres DeFrancia, Boulder, CO (US)

Correspondence Address: Kendal M. Sheets, 1855 MACARTHUR DRIVE, MCLEAN, VA, 22101, US

(21) Appl. No.: 11/698,030

(22) Filed: Jan. 26, 2007

(51) Int. Cl. B60P 3/20

(52) U.S. Cl. 280/47.26

(57) ABSTRACT

The present invention discloses a all-terrain cooler chest comprising a pair of wheels and a towing handle for portability. A back extension of storage space is provided behind the wheels that is designed to maintain the clearance from the ground for the underside of the cooler when the cooler is tilted up for towing with a handle. The invention optimizes storage space while providing ground clearance when the cooler is towed by an individual user.

### FIELD OF THE INVENTION

The present invention relates to a portable all-terrain cooler chest that typically has at least one insulated compartment used to transport food, drinks, or perishable items in a cooled or heated state.

### BACKGROUND OF THE INVENTION

Portable cooler chests have been used for many years to transport food, liquids, ice, environmental samples, human tissues, or any potential items that need to remain heated or cooled during transportation. Some portable cooler chests are used on job sites for sample storage, in the medical industry for tissue transport and household uses including hauling food and beverages to picnics, beaches, and trips in a vehicle. Cooler chests are typically constructed with a top opening accessible through a lid and are insulated on the walls, floor, and lid. Some traditional coolers were constructed with a metallic outer insulation shell, but the majority of coolers manufactured today are generally made from plastics. While portable cooler chests are known for their ability to maintain perishable items for long periods of time, their drawbacks include having only a single compartment that could solely contain hot or solely cold items. Also, any wet materials could leak or spill onto dry materials in the single compartment. Drawbacks to a portable cooler are the combination of weight, hauling distance, and terrain over which the cooler is to be towed. The larger the cooler's internal volume, the more items it can hold and therefore heavier it will weigh to transport. For example, a large cooler chest containing ice and canned or bottled beverages may require more than one person to carry the cooler. Furthermore, if the carriers have to traverse loose soil, sand, rocks, or uneven terrain, the risk of losing footing or dropping the cooler due is significantly increased.

Prior art devices to address problems of transporting coolers include adding one or two pairs of wheels and a towing handle to improve mobility. There are problems, however, with prior wheeled coolers. One problem with four-wheeled coolers is that the wheels do not rotate when turning of the cooler, requiring the user to lift the front wheels up with a handle to turn the cooler as if the cooler only had two rear wheels. If a heavily loaded cooler is pulled across loose sand or gravel, the front wheels sink into the loose ground creating even more resistance against the ground. Prior art wheeled coolers also provide little to no ground clearance. This can cause the bottom of the cooler chest surface to drag the ground over uneven terrain, damage the shell and insulation, and possibly drag earthen matter and debris along with the cooler.

Prior art wheeled coolers may require that the wheels be oriented to different positions for carrying or moving. The wheel configurations provide little to no ground clearance either for the bottom of the cooler if four-wheeled or for the back of a cooler if two-wheeled. Other designs have permanently fixed wheels that extend outward from the cooler, but these designs impede hand carrying, create wasted external space if packing the cooler in a vehicle with other items, and still create difficulty in pulling over uneven or soft terrain. Some prior art wheeled cooler chests provide for retracting, pivoting, or changeable wheels and towing handles, however these designs suffer from similar drawbacks of low ground clearance and having additional movable joints on the wheels or axles that can malfunction due to sand, dirt, and rust as well as requiring additional steps to open and retract the wheelbase. Users wanting ease of use and convenience in a towable cooler would find these features undesirable. The wheels are also not built with materials and dimensions to avoid the difficulty in pulling over uneven or soft terrain. One design in U.S. Pat. No. 5,423,195 adds four expandable and retractable wheels to use over sand and soft surfaces. This design requires numerous manual steps to prepare when expanding or retracting and are prone to mechanical failure from dirt, weeds, and debris entering and clogging the expandable wheels, the retractable spindles, and recess areas for each wheel. Further this device has low ground clearance, as mentioned above.

An additional problem with prior wheeled cooler chests that are towed on two permanent wheels is that the storage area is inadequate and inefficient when wheels are attached. If larger wheels are used, the wheels extend out from the cooler walls making the footprint of the entire chest larger, and if wheels are recessed into the cooler's rectangular footprint they are made smaller, causing the problems stated above. Traditional wheeled cooler chest designs also fail to account for tipping upright or backwards if the towing handle is accidentally turned loose while a user is towing the chest. Another design feature not included in prior wheeled coolers is accounting for the height and arm length of a person pulling the cooler chest. The lack of a handle design and wheel design that incorporates the height of a person and dimensions of the cooler in order to maximize the internal volume while minimizing the space taken by the wheels is a problem with the prior art wheeled cooler chests.

Another drawback of prior cooler chests is a lack of adequate compartmentalization. A user of a cooler may want to haul hot and cold food and drinks in the same cooler and have a dry compartment and wet compartment to separate ice or liquids in containers that could spill from dry food such as bread. U.S. Pat. No. 6,474,097 uses compartments of an ice cooler section for holding ice and iced food and drink and a separate thermos inside a cooler chest. A compartment above the ice cooler section is designated as storage, however this compartment is in contact with the ice cooler section and could easily be subject to contact with ice, liquids, or food in the main compartment. Further, there is no hot food compartment, moreover one that is thermally separated from the ice cooler section. Prior portable chests provide no ability to stage food items in a thermally intelligent manner to maximize the length of time hot foods stay hot and cold foods stay cold.

As described below, the present invention, described by preferred and alternative embodiments, overcome the deficiencies of the prior art.

### SUMMARY

The present invention, as described in the preferred and alternative embodiments, includes an all-terrain portable cooler chest that maximizes storage capacity around the addition of wheels. The cooler storage area is build around wheels that are recessed and made flush with the plan-level footprint of the chest so that they do not extend out from the cooler's footprint. The features maintain the cooler's clearance from the ground so that it will not drag when tilted up for towing with a handle.

The preferred cooler provides optimized space in the storage compartments while at the same time providing ground clearance calculated to be high enough to clear soft terrain such as sand on a beach and gravel without the cooler body scraping the ground and dragging along dirt and debris while being pulled by an individual of above-average height. An extension on the back-end of the cooler creates additional storage area and prevents the cooler from up-ending and tipping backwards if the cooler handle is lifted too high.

### BRIEF DESCRIPTION OF THE DRAWINGS

For a better understanding of the nature of the present invention, its features and advantages, the subsequent detailed description is presented in connection with accompanying drawings in which:

FIG. 1 is a diagram of the preferred embodiment for a portable cooler chest;

FIG. 2 is a side view diagram of the preferred embodiment for a portable cooler chest;

FIG. 3 is a plan elevation diagram of the preferred embodiment for a portable cooler chest;

FIG. 4 is a back view diagram of the preferred embodiment for a portable cooler chest;

FIG. 5 is a front view diagram of the preferred embodiment for a portable cooler chest;

FIG. 6 a side view diagram of the preferred embodiment for a portable cooler chest with a towing handle in a closed position;

FIG. 7 is the front view of FIG. 5 with a lift-up table in an extended position;

FIG. 8 illustrates a series of tested design heights for the preferred cooler comprising a four-inch back extension;

FIG. 9 illustrates a series of tested design heights for the preferred cooler comprising a three-inch back extension;

FIG. 10 illustrates a series of tested design heights for an alternative cooler comprising a two-inch back extension;

FIG. 11 illustrates a view of the preferred embodiment of FIG. 1 with each lid in an open position;

FIG. 12 illustrates a side view of an alternative embodiment of a cooler;

FIG. 13 illustrates a front view of an alternative embodiment of a cooler; and

FIG. 14 illustrates a rear view of an alternative embodiment of a cooler.

### DETAILED DESCRIPTION OF THE INVENTION

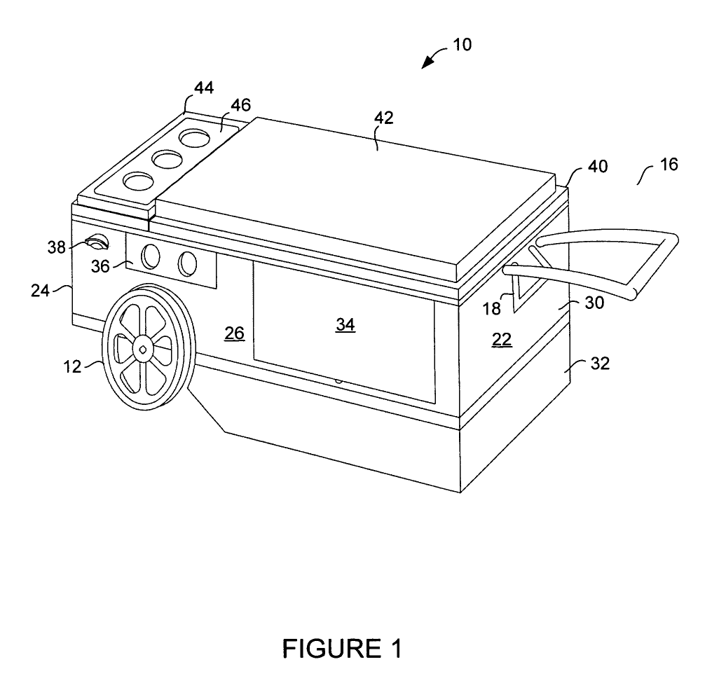

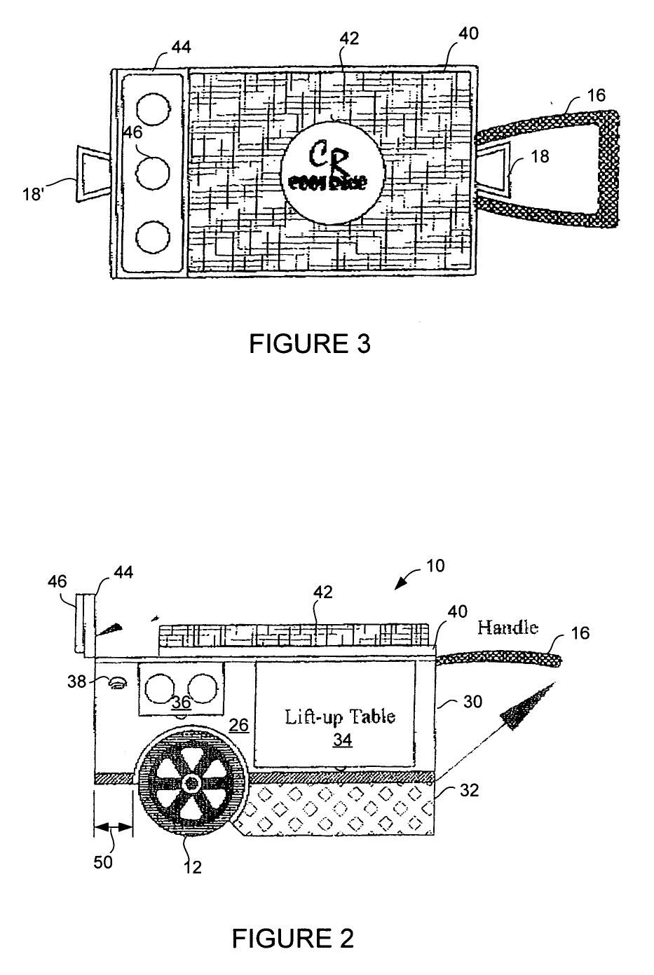

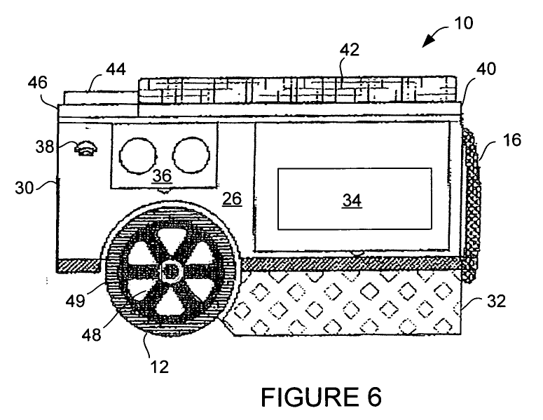

The preferred and alternative embodiments of the present invention include a portable cooler chest that is transportable via wheels attached to the near one end of the chest and a pulling, or towing, handle attached to an opposite end. Referring to FIG. 1, the portable cooler chest assembly of the preferred embodiment 10 is illustrated in a perspective view. Mobility of the chest 10 is provided by a pair of wheels 12, 14 attached at an end of the cooler, while at an opposite end of the cooler to the wheels, a towing handle 16 is attached to the cooler wall. Handle 16 pivots vertically so that the handle may fold down against the cooler or lift up to a stopping point so that a user may pull the cooler by hand. The mobile aspects of cooler 10 are discussed in more detail in regards to FIGS. 2 through 7. When a user desires to lift or move the portable cooler 10 without using wheels 12 and 14, lifting handles 18 and 18′ (see FIG. 3) are attached at opposite ends of the cooler. Lifting handles 18, 18′ normally rest against cooler walls but pivot vertically so that one or more users may lift the cooler by hand from one or both lifting handles.

For purposes of describing the preferred portable cooler 10, the orientations of the end of cooler 10 are defined as the front end 22 has attached towing handle 16, back end 24 is not show in FIG. 1 but is shown in the later figures, right side 26 and left side 28. Features of the preferred cooler assembly 10 include a main cooler compartment 30 and a lower cooler compartment extension 32. An extendable table 34 is attached or hinged to right side cooler wall 26 and is stowed by lying against wall 26 and extends to fold out and lock in place. Right side wall 26 also contains a cup holder 36 that is configured to extend up and lock so that drinks or cups may be placed in each circular cup holder space. A bottle opener 38 is provided on a side of the cooler 10 for convenience of opening caps from bottled drinks.

The internal compartments 30, 32 of the cooler 10 are accessed in two different access points. The first access point is through the top of cooler 10 by opening lid 40, which is attached to, or removable from, cooler 10 and opens to provide access to the interior. A removable seat cushion 42, may be placed on top of lid 40. The lid 40, however, does not cover the entire top of the chest 10. In order to provide a second access point through quick cooler access lid 44, quick cooler access lid 44 opens to, or is removable from, the top of the cooler 10 and provides a smaller lid than lid 40. Quick access lid 44 comprises one or more cup holders 46 that are usable to hold cups and beverages when lid 44 is closed. These and other features of the preferred and alternative embodiments are described in more detail in FIGS. 2 through 7.

FIG. 2 illustrates a side view of preferred portable cooler chest 10. Towing handle 16 is extended away from compartment 30 in a position that would be used to pull the cooler 10. Handle 16 rests in a normally down position but extends to a maximum vertical distance to use for towing the cooler 10. Handle 16 pivots around a hinged or spring connection on the front end of the cooler at a distance close to the top of compartment 30 and generally centered on the front end 22, as shown in the top view of FIG. 3 and front view of FIG. 5. Towing handle 16 must have a stop that prevents the free end from reaching an approximate vertical position above the lid 40, which would cause difficulty in towing the cooler properly. Lid 40 is shown in a closed position that encloses part of the top of compartment 30. Lid 40 is removably attached to the top of portable cooler chest 10, either by a hinge, tether, Velcro, or other connections known in the art. Lid 40 may remain connected to chest 10 by its attachment or may be completely separable. Seat cushion 42 is removably attached to lid 40 in any suitable manner such as snaps, ties, and Velcro. The removable cushion 42 can be used for a person to sit comfortably on cooler 10 or can be detached and used a traveling seat cushion for watching a stadium or theater event.

Lid 40 does not cover the entire length of cooler 10. A second lid, the quick cooler access lid 44, covers a smaller portion of the top of cooler 10. Lid 40 and quick access lid 44 independently open and close. FIG. 2 shows quick access lid 44 in an open, vertical position, providing access to the back end of the cooler compartment 30. Quick access lid 44 can be removably attached to the top of portable cooler chest 10, either by a hinge, tether, Velcro, or other connections known in the art and may remain connected to chest 10 by its attachment or may be completely separable. FIG. 11 illustrates preferred cooler 10 with lid 40 and quick access lid 44 in an open and upright position The interior of main cooler compartment 30 comprises a divider 47 between an access space covered by lid 44 and an access space covered by lid 40. Cooler 10 has the capacity to store food items such as bread and meat in a dry area within the access spaces of cooler compartment 30 that can to keep the food items from absorbing water resulting from melted ice stored in a wet compartment.

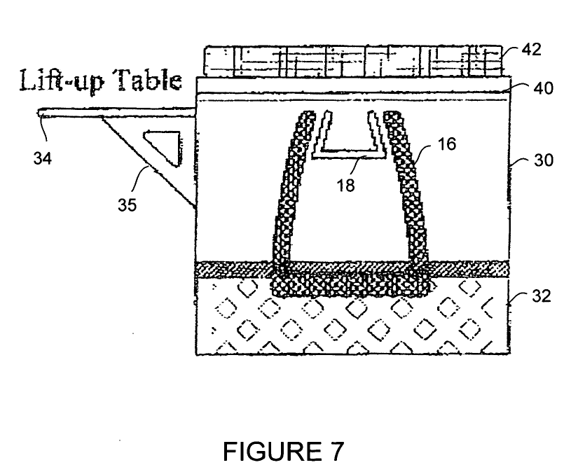

FIGS. 2 and 7 illustrate other features that are installed on a side of the preferred cooler 10. Extendable table 34 attaches to compartment 30 outer wall 26 such that the table can raise and lower manually. When lowered, table is parallel with right side wall 26 and when raised it is approximately perpendicular to the wall. Table 34 is held perpendicular by a collapsible brace support 35, which may be locked into place once extended in order to stabilize the table 34. An additional feature is lift-up cup holder 36, which when lowered lies along right side wall 26 can be extended and locked approximately perpendicular to wall 26. Cup holder 36 is held perpendicular by a collapsible brace support (not shown), which may be locked into place once extended in order to stabilize the cup holder 36. By placing cup holder 36 on a side 26, 28 of cooler 10, a user can store a beverage without having to place the beverage on the cooler lid 40 or on beverage holder 46 and thereby obstruct access to the internal compartment 30.

FIG. 3, a plan view of the preferred cooler 10, illustrates lift handle 18 and lift handle 18′ in extended positions. The figure further shows cup holder bracket 46 that is attached to the top of, and is movable with, quick access lid 44. Quick access lid 44 and cup holder 46 are shown in a closed position in FIG. 3 and in open position in FIG. 2. The length of lid 44 should be shorter than the length of lid 40. Quick access lid 44 may remain connected to cooler 10 using a hinge, tether, or similar connection that creates access to the internal compartments 30 and 32 or may completely remove from the cooler chest.

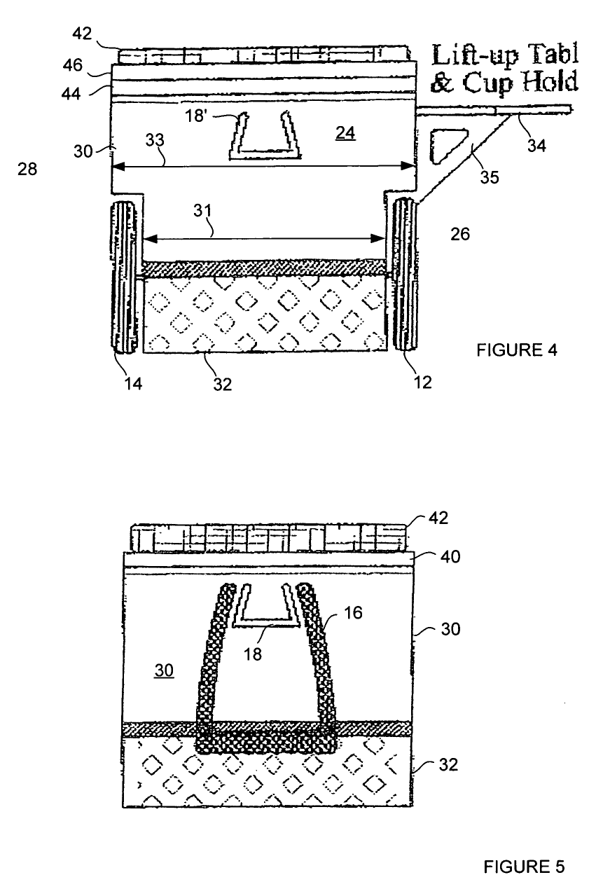

FIG. 4 illustrates the rear view of preferred cooler 10 having first wheel 12 and second wheel 14. Wheel 12 is connected to cooler 10 via an axle that rotatably inserts into the cooler using a bushing, bearing, or other typical connection. Similarly, wheel 14 is connected to cooler 10 via an axle that rotatably inserts into the cooler using a bushing, bearing, or other typical connection. An alternative embodiment connects wheels 12 and 14 to cooler using a single axle running under or through the cooler. Wheels 12, 14 comprise a spoked rim 48 and rubber tire 49 mounted onto the rim 48.

To create ground clearance, the diameter of the wheels 12, 14 including rims and tires, if any, should be long enough to provide for the additional compartment storage extension 32, which creates a larger overall storage volume than a typical rectangular boxed cooler. In one implementation of the preferred cooler, wheels 12, 14 are sized as nine to eleven inches but preferably are ten inches in diameter. Wheels 12, 14 can include additional rubber tires installed on a rigid wheel frame in order to provide a softer ride. The full width of the cooler is twenty inches and the full height is eighteen inches. One skilled in the art knows that these dimensions are merely exemplary and will vary depending on the specific implementation of the embodiments. The extension 32 follows the rectangular dimensions of the main compartment 30 and begins at front end wall 22 and stops at the beginning of each wheel 12, 14. The depth of compartment extension 32 is provided as the approximately radius of wheel 12 in order to provide a base for stabilizing the cooler in a level position together with wheels 12 and 14 with when the cooler at rest.

Further, as shown in plan view of FIG. 3, the footprint of the preferred cooler is designed to remain as an approximate rectangle, thereby avoiding the problems and disadvantages with prior wheeled coolers that have wheels protruding out from the cooler, disrupting the rectangular shape, or from rotating within or under the cooler. In order to overcome another disadvantage of prior coolers, the storage capacity of the preferred cooler 10 is maximized to make up for available storage capacity lost by the addition of wheels 12, 14. Compartment 30 is narrowed from width 33 to width dimension 31 in order to hide wheels 12, 14 within an area created by reducing the width of compartment 30 and forming the cooler around the wheels. Plan view in FIG. 3 illustrates how wheels 12 and 14 are fully hidden from the top view. FIG. 4 further illustrates how the width of the main cooler compartment 30 is narrowed to width dimension 31 so that each wheel is hidden underneath the cooler 10. This placement of the wheels 12, 14 avoids the need for pivoting or retractable wheels while it provides the preferred cooler 10 a traditional rectangular footprint, which is advantageous for shipping and packing. Dimension 31 should be wide enough so that each wheel 12, 14 fit completely underneath the remaining dimension width 33.

A fender 35 is created by forming both compartments 30 and extension compartment 32 around wheel 12. The opposite side of the cooler 10 is similarly formed around wheel 14. In FIG. 2, compartment extension 32 stops at wheel 12 and is curved around the portion of the wheel near to it in order to provide space for the wheel 12 and a fender area 35. Compartment 30 is also curved to follow around the perimeter of the wheel 12 to provide a fender area 35. Although not shown, left side 28 of cooler 10 incorporates these features for wheel 14.

To further maximize the cooler chest compartment areas 30 and 32, the compartment 30 comprises a back extension behind wheels 12 and 14. For explanation of this feature, the views of FIG. 2 will be used. The preferred length 51 of back extension 50 should extend the rectangular length of the cooler 10 while providing a maximum possible additional to storage volume to compartment 30. To maximize storage, the base of back extension 50 of the cooler extends past the wheels 12, 14 to a point where it can maintain ground clearance when the cooler is tilted up with handle 16.

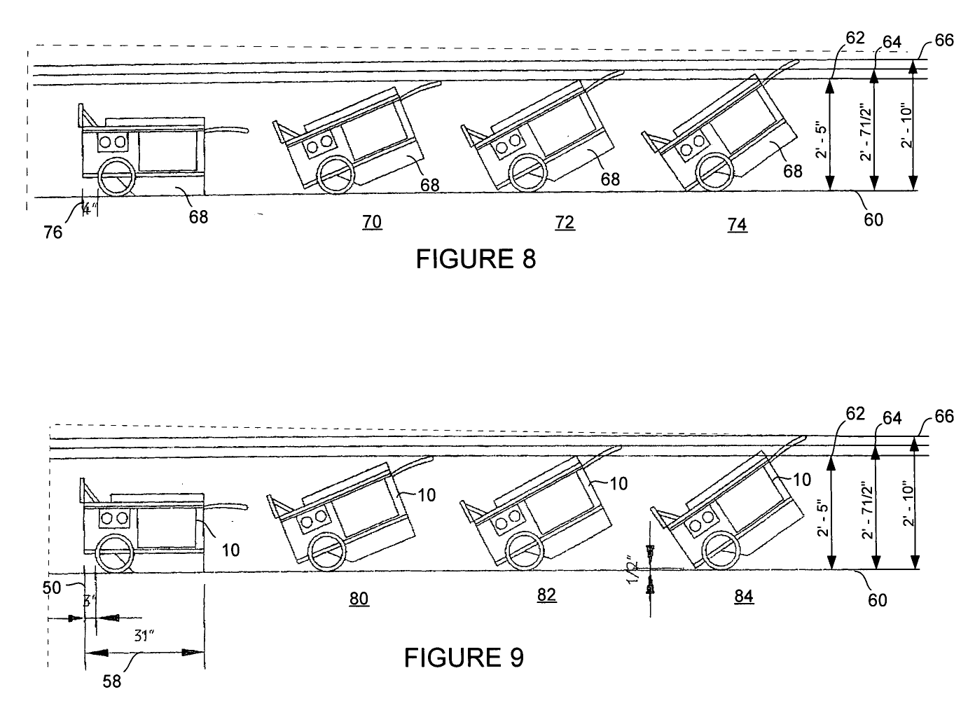

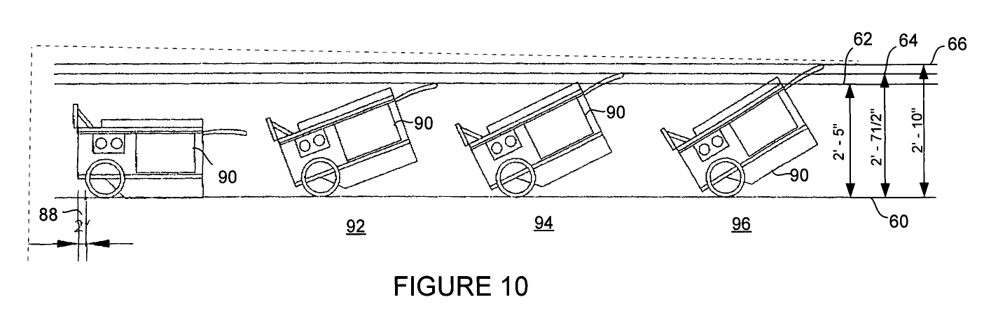

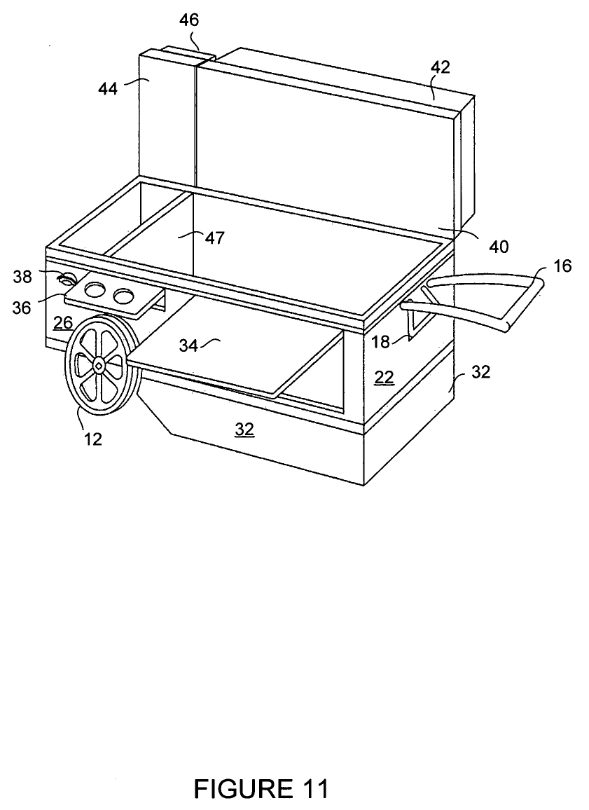

The dimensions for preferred and alternative embodiments are explained in reference to FIG. 8, FIG. 9, and FIG. 10. The preferred cooler comprises exemplary dimensions of width 54 of twenty inches, height 56 of eighteen inches, length 58 of thirty-one inches, wheel 12, 14 diameters of ten inches each, and a handle 16 length of approximately eleven to twelve inches. FIG. 8, FIG. 9, and FIG. 10 illustrate the portable cooler having alternate lengths of back extension 50 and show the cooler tilted to three different handle heights of 2′-5″ at line 66 as “lower height”, 2′-7½″ at line 64 as “middle height”, and 2′-10″ at line 66 as “upper height”, from ground 60. The height of tilt from the free end of handle 16 to line 66 is calculated as the raised height of the end of handle 16 by an average arm length of a person who is 6′-3″ in height. Various configurations for embodiments were used to determine and optimum cooler dimension and optimum cooler compartment back extension 50 dimensions that would allow towing from the upper height 66 level while avoiding dragging the cooler extension 50 along ground surface 60.

Referring to FIG. 8, one alternative embodiment for a portable cooler chest 68 is similar in all respects as the preferred cooler 10 except for being configured with a four-inch back extension 76. In configuration 70, cooler 68 tilts so that a handle 16 of 11⅝ inches reaches up to the lower height 62. At this handle height 62, compartment 32 back extension 76 does not touch the ground 60. In design test 72, the four-inch back extension 76 also fails to touch ground 60 when handle 16 is lifted to middle height 64. However, in configuration 74, when handle 16 is tilted to upper height 66, the back extension 74 touches ground 60 and would drag if cooler 68 were moved in tilted configuration 74. The four-inch back extension 76 is therefore less desirable as an optimal dimension of a back extension for cooler 10.

In FIG. 9, an length of an extended cooler compartment 50 of three inches is shown, thereby providing an optimum cooler length 58 of thirty-one inches. In configuration 80, handle 16 is raised to lower height 62, whereby the cooler 10 is titled but has space between back extension 50 and ground 60 to tow the cooler 10 without dragging the ground 60. In configuration 82 handle 16 is raised to middle height 64 and back extension 50 clears the ground 60. In configuration 84, cooler 10 is tilted to where handle 16 is at the upper height 66. At this tilt 84 with ten-inch diameter tires 12, 14, a three-inch back extension 50 with a 31-inch total length cooler 10 does not contact ground 60. The clearance between a back edge of extension 50 and ground 60 in the preferred configuration is one-half inch shown as dimension 86.

Referring to FIG. 10, alternative cooler 90 is similar in all respects to preferred cooler 10 except for being configured with a two-inch back extension 88. FIG. 10 shows configuration 92 of tilting the cooler 90 to lower height 62 in, middle height 64 in configuration 94, and upper height 66 in configuration 96. The two-inch back extension 88 did not contact ground 90 is any configuration. While this is a desirable result, it is not optimal result since the three-inch back extension 50 provides for more compartment 30 space to hold goods within cooler 10 but still avoids contacting the cooler with ground 60 at the highest design elevation 66. Therefore, alternative cooler 90 comprising a back extension of two inches avoids the ground 60 when being tilted at upper height 66, but the preferred length is two-to-three inches of a back extension, creating a more efficient design to increase storage volume of a cooler 10.

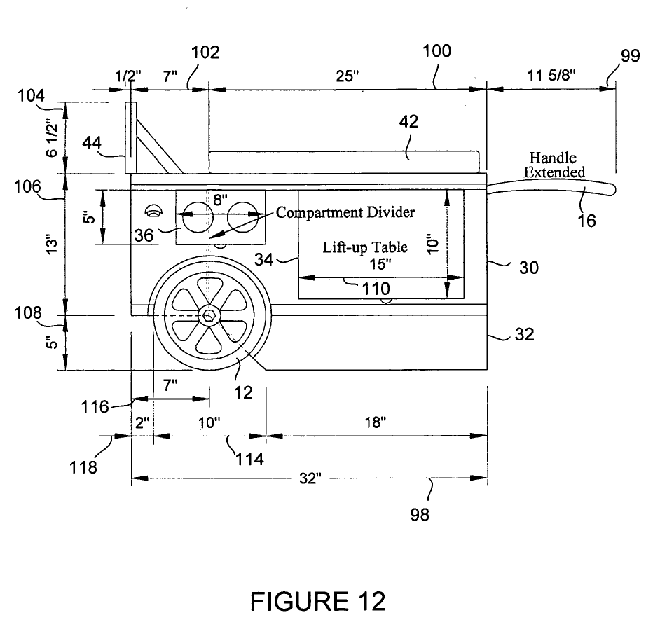

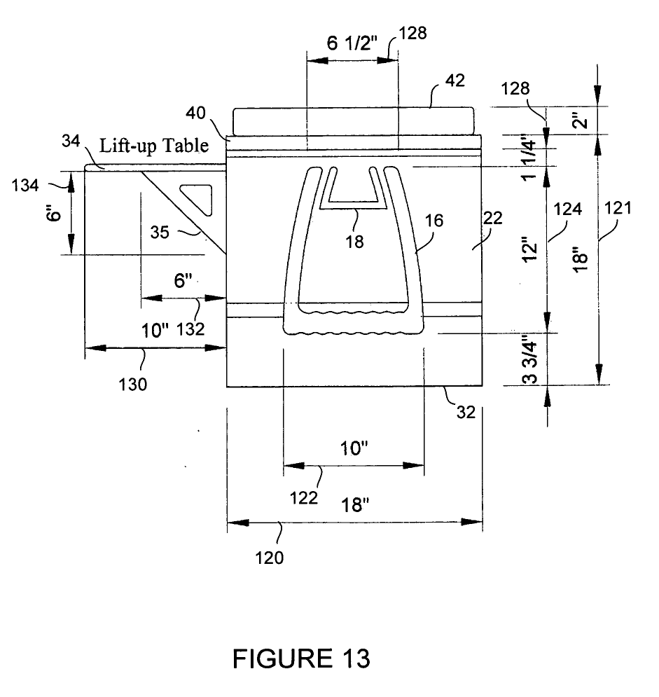

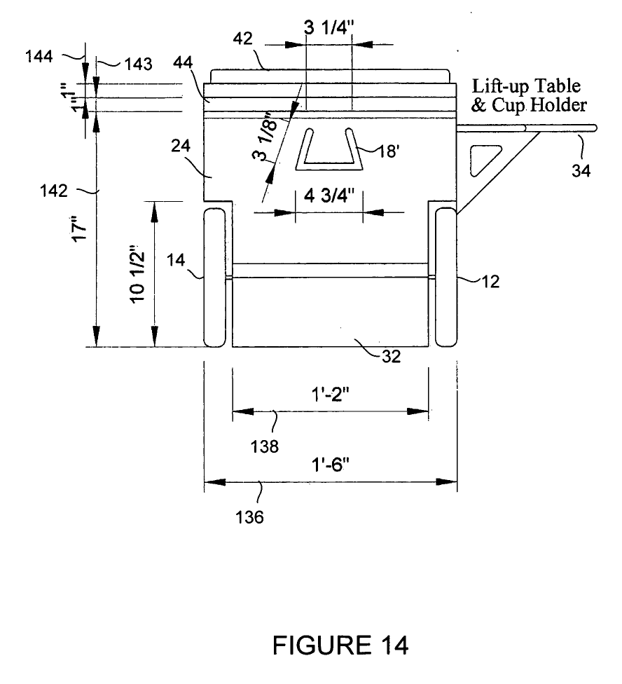

An alternative exemplary embodiment of the present invention is illustrated in FIG. 12, FIG. 13, and FIG. 14. Alternative all-terrain cooler 110 comprises features of the preferred cooler 10 that are formed to approximate dimensions. As one skilled in the art understands, dimensions of alternative cooler 110 are exemplary and can vary. FIG. 12 shows a side view facing right side 26 of cooler 110. Side 26 is formed with a thirty-two inch overall length 98 of the main cooler compartment 30. Wheel 12 diameter is ten inches in length 114, leaving eighteen inches length 112 between the forward edge of wheel 12 and front 22 of cooler 110. Between the center of wheel 12 and back end 24 is seven inches in length 116, providing a two inch length 118 of a back extension between wheel 12 and back end 24 of cooler 110 that optimizes space for compartment 30 as well as mobility as described above in reference to FIGS. 9, 10, and 11.

Alternative cooler 110 is further formed with towing handle 16 having a length of 11⅝ inches 99. Lid 40 has a length of twenty-five inches 100 and lid 44 is shown in an open position but also having a length of seven inches 102 and open height of 6½ inches 104. Referring contemporaneously to FIGS. 13 and 14, alternative cooler 110 has height of seventeen inches 142 from the bottom of lower compartment 32 to the top of main compartment 30 at the front of the cooler shown in FIG. 13. However, at the back end 24, only main compartment 30 of twelve inches in height extends behind the wheels 12, 14. Lower compartment 32 forms a bottom of the cooler 110 for eighteen inches 112 and the volume is then reduced by sloping the bottom edge towards the area of compartment 30 that is parallel to a center axis of wheels 12 and 14. From the beginning of the reduction of compartment 32 to the back end of the cooler is ten inches 114.

FIG. 13 illustrates a front view of alternative cooler 110, comprising dimensions of eighteen inches in width 120 and eighteen inches in height 121 that includes lid 40. Towing handle 16 is ten inches wide 122 at the gripping portion, 6½ inches wide 128 at the connection points, and twelve inches long 124 at a resting position. Handle 16 is connected to compartment 30 at 1¼ inch 126 below the top edge of compartment 30 and rests at 3¾ inches 122 above the bottom of compartment 30. Extension table 34 is ten inches wide 130 when extended and supporting bracket 35 is six inches 132 by six inches 134 as illustrated.

FIG. 14 illustrates a rear view of alternative cooler 110 comprising wheels 12 and 14 mounted on opposite sides of the cooler, but recessed under compartment 30. Recessed space of compartment 30 creates fenders that are 10½ inches 140 from the base of each wheel on a flat surface. Compartment 30 is seventeen inches 142, with quick access lid 44 adding one inch 143 and cup holder 46 adding one inch 144 to the overall height.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A cooler chest, comprising:
a front end, a back end, a base, a top, a first side, and a second side that form a boxed storage compartment;
a first wheel installed on the first side and a second wheel on the second side, wherein each wheel is mounted on a same transverse line to keep the cooler in a level position and the storage compartment is formed around each wheel and each wheel does not protrude beyond the footprint of the storage compartment;
a first lid on the top providing access to an internal space of the cooler; and
a handle, movably attached at one end to the front end of the cooler,
wherein the back end comprises a back storage extension of the storage compartment that extends a distance past each wheel of at least two inches.

2. The cooler chest of claim 1, wherein the storage compartment comprises a storage extension that extends from the front end and stops prior to reaching a transverse line defined between an edge of each wheel closest to the front end.

3. The cooler chest of claim 2, wherein the storage extension provides a bottom of the cooler that is approximately as high as a radius of each wheel and contacts a ground surface when the cooler is at rest, and

4. The cooler chest of claim 1, further comprising:
a second lid mounted adjacent to the first lid, wherein the storage compartment comprises two access points created by the first lid and the second lid.

5. The cooler chest of claim 1, wherein the two access points each access a different dry and wet storage areas within the storage compartment.

6. The cooler chest of claim 1, wherein, when the cooler is tilted such that a free end of the handle reaches a height of 2′-10″, the back extension does not touch a ground surface that is parallel to the cooler base when the cooler is not tilted.

7. The cooler chest of claim 6, wherein the handle extends approximately eleven to twelve inches in length.

8. The cooler chest of claim 1, wherein each wheel is separately connected to the cooler using a rotatable connection on the axle of each wheel.

9. The cooler chest of claim 6, wherein each wheel is of the same diameter that provides ground clearance for the cooler to be lifted at the handle without the back extension touching the ground surface.

10. A cooler chest, comprising:
a front end, a back end, a base, a top, a first side, and a second side that form a boxed storage compartment;
a first wheel installed on the first side and a second wheel on the second side, wherein each wheel is mounted on a same transverse line to keep the cooler in a level position and the storage compartment is formed around each wheel and each wheel does not protrude beyond the footprint of the storage compartment;
a first lid on the top providing access to an internal space of the cooler; and
a handle, movably attached at one end to the front end of the cooler,
wherein the back end comprises a back storage extension of the storage compartment that extends a distance past each wheel of at least two inches.
